(19) United States
(12) Patent Application Publication
(10) Pub. No.: US 2018/0267839 A1
(43) Pub. Date: Sep. 20, 2018

(54) Controlled Energy Utilization In A Computing Device

(71) Applicant: Microsoft Technology Licensing, LLC, Redmond, WA (US)

(72) Inventors: Paresh Maisuria, Issaquah, WA (US); James Anthony Schwartz, JR., Seattle, WA (US); M. Nashaat Soliman, Redmond, WA (US); Candy Chiang, Redmond, WA (US); Aniruddha Jayant Jahagirdar, Bellevue, WA (US); Matthew Todd Hoehnen, Seattle, WA (US); Matthew Holle, Kirkland, WA (US)

(73) Assignee: Microsoft Technology Licensing, LLC, Redmond, WA (US)

(21) Appl. No.: 15/463,918

(22) Filed: Mar. 20, 2017

(51) Int. Cl. G06F 9/50; G06F 9/48; G06F 1/32

(52) U.S. Cl. CPC G06F 9/5094; G06F 1/329; G06F 9/4893

(57) ABSTRACT

When an activity agent desires to perform a particular task on a device, the activity agent communicates a request to a resource control system of the device. The request has an associated amount of energy that is expected to be used by the activity agent to perform the task. The resource control system receives the request, determines whether to grant the request based on the amount of energy expected to be used by the activity agent to carry out the task and various additional factors, and returns an indication to the activity agent that the request is granted or denied. If denied, the activity agent delays performing its desired task. If granted, the activity agent proceeds to perform its desired task. The resource control system also continues to monitor the system state of the device, and may revoke the grant depending on changes in the system state of the device.

### BACKGROUND

As technology has advanced, computing devices have become increasingly commonplace. Computing devices provide various functionality to users, allowing the users to communicate with other users, share information, interact with applications, and so forth. One challenge that faces developers of computing devices is efficient power management. If power management implemented for a device fails to provide low energy usage, users can become dissatisfied with the devices and device manufacturers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a request is received, from an activity agent on a computing device, for permission to perform one or more tasks. The request has an associated amount of energy that is expected to be used by the activity agent to perform the one or more tasks, an associated duration to perform the one or more tasks, an associated urgency of the one or more tasks, and/or an associated classification of the one or more tasks. Based at least in part on a current system state of the computing device and the amount of energy expected to be used by the activity agent to perform the one or more tasks, a determination regarding whether to grant the request is made. In response to determining not to grant the request, a denial of the request is returned to the activity agent. In response to determining to grant the request, a grant of the request is returned to the activity agent.

In accordance with one or more aspects, a request is communicated to a resource control system for permission to perform one or more tasks. The request has an associated amount of energy that is expected to be used by an activity agent to perform the one or more tasks, an associated duration to perform the one or more tasks, an associated urgency of the one or more tasks, and/or an associated classification of the one or more tasks. An indication of whether the request is granted is received, the granting of the request having been determined based at least in part on a current system state of the computing device and the amount of energy expected to be used by the activity agent to perform the one or more tasks. In response to the request being granted, the one or more tasks are performed. In response to the request being denied, performance of the one or more tasks is delayed.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example operating environment in which the controlled energy utilization in a computing device can be implemented in accordance with one or more embodiments.

FIG. 2 is a flowchart illustrating an example process for implementing controlled energy utilization in a computing device in accordance with one or more embodiments.

FIG. 3 is a flowchart illustrating another example process for implementing controlled energy utilization in a computing device in accordance with one or more embodiments.

FIG. 4 illustrates an example system that includes an example computing device that is representative of one or more computing systems and/or devices that may implement the various techniques described herein.

### DETAILED DESCRIPTION

Controlled energy utilization in a computing device is discussed herein. Various different activity agents can request to perform one or more tasks that consume energy. An activity agent refers to a program (e.g., an application, a service, a driver) and/or hardware that performs some task in a computing device, such as transferring data, performing maintenance, and so forth. The performance of a task consumes energy due to various devices operating in the computing device, such as a processor, storage device, network interface card, and so forth.

When an activity agent desires to perform a particular task, the activity agent communicates a request to a resource control system of the computing device. The request has an associated amount of energy that is expected to be used by the activity agent to perform the task. This associated amount of energy can be indicated by the activity agent and/or determined by the resource control system. For example, the activity agent can indicate relative or absolute quantum of energy required. By way of another example, the activity agent can indicate an amount of time and/or type of activity and/or classification of activity that the activity agent desires to perform, and the resource control system can derive the amount of energy expected to be expensed for the request, and so forth.

The resource control system receives the request and determines whether to grant the request. The resource control system determines whether to grant the request based on the amount of energy expected to be used by the activity agent to carry out the task and various additional factors. One factor the resource control system can use in determining whether to grant the request is an amount of energy remaining in an energy storage device of the computing device. Another factor the resource control system can used in determining whether to grant the request is anticipated future energy consumption for the computing device and/or anticipated future access to an external power source (e.g., to recharge the energy storage device).

If the resource control system determines not to grant the request, then the resource control system notifies the activity agent that the request is denied. In response, the activity agent does not perform its desired task at the current time. However, the activity agent may send another request or resubmit the request at a later time. Additionally or alternatively, the resource control system returns an indication that the activity agent will be notified at a later time with a token to perform the requested task when the resource control system deems the conditions to perform the requested task are conducive.

If the resource control system determines to grant the request, then the resource control system notifies the activity agent of the grant and the activity agent can proceed to perform its desired task. The resource control system also continues to monitor the current system state of the computing device, and may revoke or suspend the grant depending on changes in the system state of the computing device. Various different factors can be used to determine whether to revoke a grant, such as any of the factors used in deciding whether to grant the request.

An activity agent can also optionally query the resource control system, while performing a task, for an indication of an available activity quota the activity agent has remaining. This activity quota may be expressed as a complex of the amount of energy and time allocated to the activity agent to carry out a specific task, and the available activity quota refers to a complex of unexhausted energy and time. The activity agent can use this available activity quota to determine an order for performing parts of the task, such as in situations in which the activity agent is causing more energy to be expended than was anticipated to perform the task and thus may not be able to complete the task within the time allocated to the activity agent to carry out the task.

The techniques discussed herein thus allow the resource control system to place restrictions on energy usage in the computing device by restricting when activity agents can perform tasks. The determination of whether to allow an activity agent to perform a task is made at the time of the request, allowing the resource control system to dynamically adapt to requests for different tasks, changes in the amount of time it takes to perform tasks, and changes in the system state in the computing device and urgency of the requested task. The activity agent can further obtain an indication of the available energy quota, allowing the activity agent to prioritize tasks as it deems appropriate given the amount of energy remaining for it to perform the task.

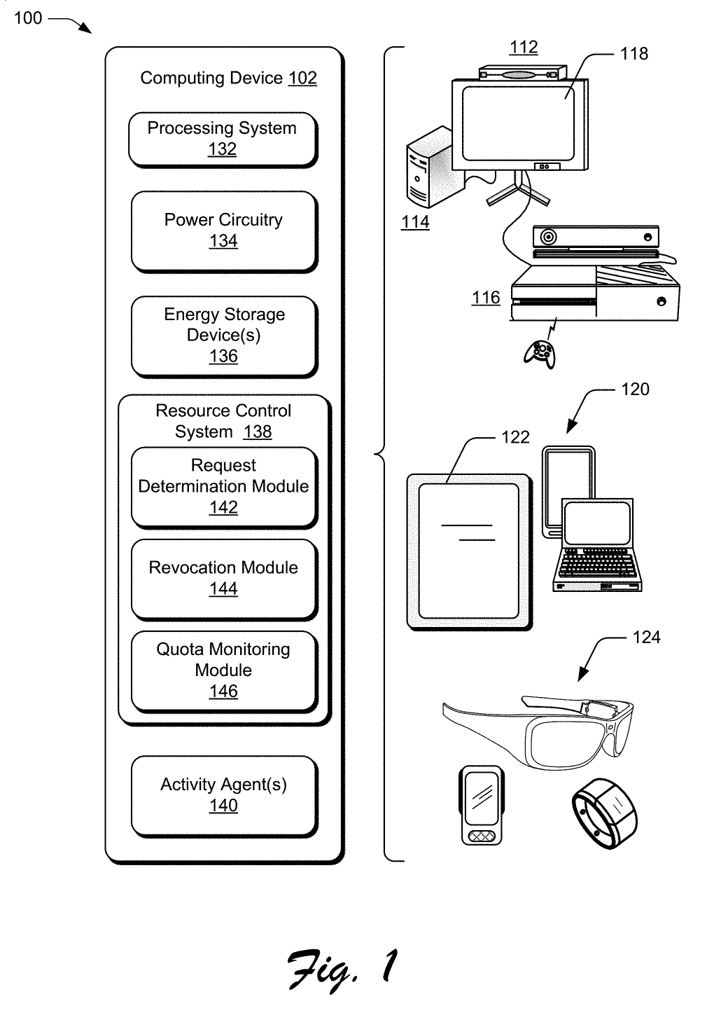

FIG. 1 illustrates an example operating environment 100 in which the controlled energy utilization in a computing device can be implemented in accordance with one or more embodiments. Operating environment 100 can be embodied as any suitable computing system and/or device such as, by way of example and not limitation, a gaming system, a desktop computer, a portable computer, a tablet or slate computer, a handheld computer such as a personal digital assistant (PDA), a cell phone, a set-top box, a wearable device (e.g., watch, band, glasses, augmented reality (AR) headsets, virtual reality (VR) headsets, etc.), and the like. For example, as shown in FIG. 1 the computing device 102 can be implemented as a television client device 112, a computer 114, and/or a gaming system 116 that is connected to a display device 118 to display media content. Alternatively, the computing device may be any type of portable computer, mobile phone, Internet-of-Things (IoT) device, or portable device 120. Such a computing device 120 optionally includes an integrated display 122. A computing device may also be configured as a wearable device 124 that is designed to be worn by, attached to, carried by, or otherwise transported by a user. Examples of wearable devices 124 depicted in FIG. 1 include glasses (e.g., augmented reality (AR) or virtual reality (VR) headsets), a smart band or watch, and a pod device such as clip-on fitness device, media player, or tracker. Other examples of wearable devices 124 include but are not limited to badges, a key fob, an access card, and a ring, an article of clothing, a glove, or a bracelet, to name a few examples. A computing device may also be implemented as part of another device or product, such as an electric vehicle. Any of the computing devices can be implemented with various components, such as one or more processors and memory devices, as well as with any combination of differing components.

The computing device 102 includes a processing system 132. The processing system 132 may be configured to include a single processor with one or more processor cores included on the same chip or integrated circuit. Alternatively, the processing system 132 may be configured to include multiple independent processors configured in parallel or in series, each including one or more processor cores included on the same chip or integrated circuit. In one or more implementations, the processing system 132 may include multiple processing cores that provide a range of performance capabilities, processing efficiencies, and power usage characteristics.

The processing system 132 can execute various firmware and/or software instructions of various modules or components of the computing device 102. These firmware and/or software instructions can include programs of an operating system (OS) of the computing device 102, programs run by the OS of the computing device 102, and so forth. For example, the processing system 132 can execute programs that provide a wide range of functionality to the computing device 102, including but not limited to gaming, office productivity, email, media management, printing, networking, web-browsing, and so forth

Computing device 102 also includes power circuitry 134 and one or more energy storage device(s) 136, from which computing device 102 can draw power to operate. Generally, power circuitry 134 includes software, firmware, and/or hardware configured to enable computing device 102 to draw operating power from energy storage device(s) 136 or to apply charging power to energy storage device(s) 136. Power circuitry 134 may also include software, firmware, and/or hardware configured to provide power received from an external power source (e.g., an external plug-in AC power source) to components of the computing device 102.

The energy storage device(s) 136 are representative of various different kinds of energy storage devices that may be included and/or compatible with the computing device 102. These energy storage devices can include, for example, individual or a collection of battery cells, supercapacitors, and so forth. The energy storage device (s) 136 may include, for example, any suitable number or type of rechargeable battery cells, such as lithium-ion (Lion), lithium-polymer (Li-Poly), lithium ceramic (Li-C), and the like. In one or more embodiments, energy storage device(s) 136 are optional. In such embodiments, the computing device 102 operates based on power received from an external power source (e.g., an external plug-in AC power source) rather than energy storage device(s) 136.

The computing device 102 also includes a resource control system 138 and one or more activity agent(s) 140. Each activity agent 140 is a program (e.g., an application, a service, a driver, etc.) and/or hardware that performs some task in the computing device 102. The resource control system 138 controls access to various resources in the computing device 102, including energy usage. Generally, each activity agent 140 can request a particular amount of energy to perform one or more tasks. This amount of energy can be determined in a variety of different manners as discussed in more detail below. The resource control system 138 determines whether to grant the request, and the activity agent 140 proceeds to perform the one or more tasks if the request is granted, and to not perform (or delay performing) the one or more tasks if the request is denied.

The resource control system 138 is configured to improve energy consumption in the computing device 102, which can include conserving energy in the energy storage device(s) 136 and/or reducing the amount of energy that is drawn from external sources. The resource control system 138 determines whether to grant a request from an activity agent 140 at least in part by factoring into its decision the goal of reducing energy consumption in the computing device 102. This determination can be made in a variety of different manners as discussed in more detail below. Furthermore, the resource control system 138 may be dynamically configured to meet goals, such as energy goal, performance goals and thermal goals. These goals may be system determined and/or user configured and/or derived from user intent.

During operation, an activity agent 140 desires to perform one or more tasks. Different activity agents 140 can perform different tasks, such as transferring data (to and/or from another computing device, to and/or from a storage device), performing maintenance, checking for malware, displaying visual data, playing back audio data, and so forth. In one or more embodiments, the tasks performed by the activity agent(s) 140 are grouped into different classifications or types of tasks, allowing the resource control system 138 to budget different amounts of energy to different classifications or types of tasks as discussed in more detail below. These classifications or types of tasks can be, for example, network tasks (e.g., to transfer/receive network files), media tasks (e.g., to capture/render media), background and maintenance tasks (e.g., run antivirus scan), and so forth.

In response to a desire to perform a task, an activity agent communicates a request to a request determination module 142 of the resource control system 138. The request is a request for permission to perform the one or more tasks. The request determination module 142 determines whether to grant the request based on various factors, such as an indication of how much energy the activity agent expects to use to perform the one or more tasks. The activity agent 140 can communicate the request to the request determination module 142 in a variety of different manners. In one or more embodiments, the request determination module 142 exposes an application programming interface (API) with one or more methods that can be invoked by the activity agent 140 to request permission to perform the one or more tasks. Alternatively, the request can be communicated using other techniques rather than invoking an API method.

In one or more embodiments, the request for permission to perform the one or more tasks includes an indication of the classification of the one or more tasks, an indication of the urgency of the one or more tasks, and/or an indication of the task duration of the one or more tasks. The indication of the classification, urgency, and/or task duration can be provided in a variety of different manners. For example, the API method invoked by the activity agent 140 to communicate the request for permission to perform the one or more tasks can include as a parameter an identification of the classification of the one or more tasks, an identification of the urgency of one or more tasks, and/or an identification of the task duration of the one or more tasks. By way of another example, the request determination module 142 can expose different API methods for different task classifications, different task urgencies, and/or different task durations, and the activity agent 140 invokes the API method associated with the classification, urgency, and/or duration of the one or more tasks the activity agent 140 is requesting to perform. By way of another example, each activity agent 140 can be associated with a particular classification of tasks, task urgencies, and/or task durations, and thus the indication of the classification, urgency, and/or duration is inherent in the activity agent 140 making the request for permission to perform the one or more tasks.

It should be noted that the exposing of an API or otherwise receiving with the request for permission an indication of the classification of the one or more tasks, an indication of the urgency of the one or more tasks, and/or an indication of the task duration of the one or more tasks, is optional. The resource control system 138 need not receive such indications with the request for permission from the activity agent 140, but rather can determine such information (e.g., classification, urgency, and/or duration of the one or more tasks the activity agent 140 is requesting to perform) automatically. The resource control system 140 can determine such information in various manners, such as using the history of requests (e.g., from the activity agents), using various heuristics, rules, or other criteria, and so forth.

The request for permission to perform the one or more tasks also has an associated indication of how much energy the activity agent 140 is expected to use to perform the one or more tasks. The performance of a task consumes energy due to various devices operating in the computing device, such as a processor, storage device, network interface card, and so forth. The indication of how much energy the activity agent 140 is expected to use refers to how much energy is consumed by these various devices during performance of the task.

In one or more embodiments, the activity agent 140 provides to the request determination module 142 the indication of how much energy the activity agent 140 is expected to use to perform the one or more tasks. The activity agent 140 can obtain this indication in various manners, such as being preconfigured with rules or criteria specifying how much energy the activity agent 140 is expected to use to perform the one or more tasks, obtaining an indication from a remote device or service of how much energy the activity agent 140 is expected to use to perform the one or more tasks, and so forth. For example, the activity agent can specify that no more than a threshold percentage (e.g., 5%) of the amount of energy in the energy storage device(s) 136 is to be used to perform the one or more tasks. This amount of energy in the energy storage device(s) 136 can be, for example, an amount of energy currently in the energy storage device(s) 136 at the time the activity agent 140 makes the request, a maximum or largest amount of energy that can be stored in the energy storage device(s) 136, and so forth.

Additionally or alternatively, the request determination module 142 can determine how much energy the activity agent 140 is expected to use to perform the one or more tasks. In one or more embodiments, the request determination module 142 maintains a record, for each task and/or activity agent 140, of how much energy was consumed to perform the task (or alternatively an amount of time it took to perform the task). When a request for permission to perform a task is received from an activity agent 140, the request determination module 142 can access this record and readily determine how much energy was previously consumed by the activity agent 140 in performing that task. If there are multiple entries in the record for the activity agent 140 performing the task (e.g., the activity agent has performed the task multiple times in the past), those multiple entries can be combined in some manner (e.g., averaged, weighted averaging so that more recent entries contribute to the average more than older entries, etc.).

In one or more embodiments, the request determination module 142 also leverages crowd sourcing to determine how much energy the activity agent 140 is expected to use to perform the one or more tasks. For example, a remote service (e.g., accessed via the Internet) can receive reports from multiple different computing devices (optionally of the same type, such as having the same processor, the same size storage device, the same amount of random access memory, etc.) regarding how much energy is consumed during performance of each of multiple different tasks. The request determination module 142 can request this information from the service and use the information to determine how much energy the activity agent 140 is expected to use to perform the one or more tasks (e.g., the request determination module 142 can assume that the activity agent 140 will consume approximately the same amount of energy to perform the task as was consumed by other activity agents on other computing devices performing the same task).

Additionally or alternatively, the request for permission to perform the one or more tasks has an associated indication of a duration (how long) the activity agent 140 is expected to take to perform the one or more tasks. This indication can be provided by the activity agent 140 and/or determined by the resource control system 138 in any of a variety of manners analogous to determining how much energy the activity agent 140 is expected to use to perform the one or more tasks.

Given the amount of energy expected to be used by the activity agent 140 to perform the one or more tasks and/or the expected duration to perform the one or more tasks, as well as a current system state of the computing device 102, the request determination module 142 determines whether to grant the request. The request determination module 142 can take into account various different factors to determine the current system state. Generally, the request determination module 142 determines, given the amount of energy expected to be used by the activity agent 140 to perform the one or more tasks, whether it is reasonable to allow the task to be performed at the current time or whether it is more appropriate for the task to be performed at a later time, and then accordingly grants or denies the request.

The current system state refers to any one or more of a current power availability and the type of power available (e.g., energy storage device(s) 136 or an external power source), settings or policies for the computing device 102, anticipated or future power availability, and so forth. One factor that the request determination module 142 can take into account to determine the current system state is an amount of energy remaining in the energy storage device(s) 136. Another factor that the request determination module 142 can take into account to determine the current system state is budgets or limits that are set for particular classifications of tasks. Another factor that the request determination module 142 can take into account to determine the current system state is predicted future energy consumption by the computing device 102. Another factor that the request determination module 142 can take into account to determine the current system state is predicted future access to an external power source (e.g., to recharge the energy storage device). Another factor that the request determination module 142 can take into account to determine the current system state is thermal conditions in the computing device 102 (e.g., a current temperature of the computing device 102). Another factor that the request determination module 142 can take into account determine the current system state is coalescing the relevant tasks requests (e.g., for related tasks) to increase energy efficiency of the computing device 102. For example, the granting or denying of a request can be delayed by the request determination module 142 for the purposes of coalescing tasks (e.g., delay granting a request so that multiple related tasks can be coalesced and the requests for permission to perform those related tasks all granted at the same time).

The request determination module 142 can use the factors in a variety of different manners to determine whether to grant a request to perform one or more tasks. Another example way in which the request determination module 142 can use the factors to determine whether to grant a request to perform one or more tasks is for the request determination module 142 to determine the amount of energy remaining in the energy storage device(s) 136. Given the amount of energy remaining in the energy storage device(s) 136 and how much energy the activity agent 140 is expected to use to perform the one or more tasks, the request determination module 142 determines whether there is sufficient energy in the energy storage device(s) 136 to perform the one or more tasks (optionally with at least a threshold amount, such as 10% of the energy capacity of the energy storage device(s) 136, remaining). The request determination module 142 grants the request if there is sufficient energy in the energy storage device(s) 136 to perform the one or more tasks, and denies the request if there is not sufficient energy in the energy storage device(s) 136 to perform the one or more tasks.

Another example way in which the request determination module 142 can use the factors to determine whether to grant a request to perform one or more tasks is for the request determination module 142 to have a budget (also referred to as a quota) for each of various classifications of tasks, and determine whether to grant a request to perform one or more tasks based on this budget. For example, assume the request is a request to perform a task having a classification of maintenance, and that the request determination module 142 has a budget that tasks having a classification of maintenance are to consume no more than a threshold percentage (e.g., 10%) of the energy capacity of the energy storage device(s) 136 over some time period (e.g., per day). The request determination module 142 keeps track of, or obtains from another module of the computing device 102, how much energy has already been expended during the current time period (e.g., the current day) performing tasks having a classification of maintenance. The request determination module 142 generates an energy sum that is the amount of energy the activity agent 140 is expected to use to perform the one or more tasks would added to the amount of energy that has already been expended during the current time period performing tasks having a classification of maintenance, and determines whether this energy sum would exceed the budget. The request determination module 142 grants the request if this energy sum does not exceed the budget, and denies the request if this energy sum does exceed the budget.

Another example way in which the request determination module 142 can use the factors to determine whether to grant a request to perform one or more tasks is for the request determination module 142 to obtain an indication of predicted future energy consumption by the computing device 102. This predicted future energy consumption can be over some given time period (e.g., the current day) or until some other predicted event (e.g., coupling the computing device 102 to an external power source, as discussed in more detail below) occurs. The request determination module 142 generates an energy sum that is the amount of energy the activity agent 140 is expected to use to perform the one or more tasks would added to the amount of energy that the computing device 102 is predicted to use has already been expended during the current time period performing tasks having a classification of maintenance, and determines whether this energy sum would exceed a threshold amount (e.g., a particular percentage, such as 70%, of the capacity of the energy storage device(s)). The request determination module 142 grants the request if this energy sum does not exceed the threshold amount, and denies the request if this energy sum does exceed the threshold amount.

The request determination module 142 can generate the predicted future energy consumption of the computing device 102, or alternatively obtain the predicted future energy consumption of the computing device 102 from another module of the computing device 102 or other device (e.g., a remote service accessed via the Internet). The predicted future energy consumption can be determined in a variety of different manners.

For example, a record (e.g., over a matter of weeks or months) indicating times of the day and/or days of the week and the power usage during those times and/or days can be maintained. From this record, usage patterns that indicate power usage of the computing device 102 can be identified using any of a variety of public and/or proprietary analysis techniques. The usage patterns can be a complex expression of more than one type of data or information, such as time, place, user activity (e.g., is the user in the meeting, is the user presenting the meeting, etc.), system generated activity, and so forth. By way of another example, the data from a calendar of the user of the computing device 102 can be obtained, and the past usage data (the record indicating times of the day and/or days of the week and the power usage during those times and/or days) can be compared to the user's calendar and a determination made that during meetings (or at particular device locations) the computing device uses a particular amount of power (e.g., 50 mW/h). The prediction can thus be made, for example, that the computing device will also use 50 mW/h during upcoming meetings (or particular locations) identified in the user's calendar, or more than 50 mW/h (e.g., 70 mW/h) if the user is marked as meeting presenter.

By way of yet another example, data from a calendar and/or digital personal assistant (e.g., the Cortana® personal assistant) of the user of the computing device 102 can be obtained. Given this obtained data, a prediction of when the user will be away from the computing device 102 (e.g., for a meeting, for coffee, etc.) can be made, and a prediction that the computing device 102 will use a small amount of power (e.g., 5 mW/h) while the user is away from the computing device 102 can be made. By way of yet another example, location data for the computing device 102 can be obtained (e.g., using a global positioning system (GPS), Bluetooth, Wi-Fi, triangulation, and so forth). A past usage data (a record indicating times of the day and/or days of the week and the power usage during those times and/or days) can be compared to the user's locations and a determination made that at certain locations (e.g., home) the computing device 102 uses a particular amount of power (e.g., 100 mW/h). The prediction can be made, for example, that the computing device 102 will also use 100 mW/h if the user is currently at home.

By way of another example, the request determination module 142 can obtain an indication of predicted future access for the computing device 102 to an external power source (e.g., to recharge the energy storage device(s) 136). The external power source can be an AC power source or some other power source external to the computing device 102. The request determination module 142 grants the request if the computing device 102 is predicted to have access to an external power source within a threshold amount of time (e.g., 30 minutes) and/or prior to some event occurring (e.g., the energy storage device(s) 136 running below a particular charge level, such as 20% of the capacity of the energy storage device(s)), and denies the request if the computing device 102 is predicted to not have access to an external power source within the threshold amount of time (e.g., 30 minutes) and/or prior to the event occurring.

Another example way in which the request determination module 142 can use the factors to determine whether to grant a request to perform one or more tasks is for the request determination module 142 to generate the predicted future access to an external power source, or alternatively obtain the predicted future access to an external power source from another module of the computing device 102 or other device (e.g., a remote service accessed via the Internet). The predicted future access to an external power source can be determined in a variety of different manners.

For example, a record (e.g., over a matter of weeks or months) indicating times of the day and/or days of the week that the computing device connected to an external power source can be maintained. From this record, usage patterns that indicate when the computing device 102 is connected to an external power source and the durations when the computing device is connected to an external power source can be identified using any of a variety of public and/or proprietary analysis techniques. For example, if every Sunday (or at least a threshold number of Sundays, such as 80%) from noon to midnight the computing device 102 is connected to an external power source, then it can be predicted that on the following Sunday from noon to midnight the computing device 102 will be connected to an external power source. By way of another example, if every day of the week (or at least a threshold number of days, such as 75%) from midnight to 6:00 am the computing device 102 is connected to an external power source, then it can be predicted that, if it is currently 11:00 pm, the computing device will be connected to an AC power source the following day from noon to 6:00 am.

By way of another example, data from a calendar of the user of the computing device 102 can be obtained. The past usage data (the record indicating times of the day and/or days of the week that the computing device connected to an external power source) can be compared to the user's calendar and a determination made that during meetings (or meetings at particular locations) the computing device is connected to an external power source. The prediction can be made that, for example, the computing device 102 will be connected to an external power source during upcoming meetings (or meetings at particular locations) identified in the user's calendar.

By way of yet another example, location data for the computing device 102 can be obtained (e.g., using a GPS, Bluetooth, Wi-Fi, triangulation, and so forth). The past usage data (the record indicating times of the day and/or days of the week that the computing device 102 is connected to an external power source) can be compared to the user's locations and a determination made that at certain locations (e.g., home) the computing device 102 is connected to an external power source. It can be predicted that, for example, the computing device 1-2 will be connected to an external power source if the user is currently within a threshold distance (e.g., one mile) of home, but not connected to an external power source if the user is currently within a threshold distance (e.g., one mile) of work and heading towards work (based on calendar entries, meeting appointments, heading on map/navigation application, etc.).

Another example way in which the request determination module 142 can use the factors to determine whether to grant a request to perform one or more tasks is for the request determination module 142 to obtain an indication of current thermal conditions in the computing device 102. The current thermal conditions in the computing device 102 refer to, for example, the current temperature of the device, whether the temperature of the device has been increasing over some previous threshold amount of time (e.g., the previous 5 minutes), whether the temperature of the device has been decreasing over some previous threshold amount of time (e.g., the previous 5 minutes), and so forth. The request determination module 142 grants the request if thermal conditions satisfy a threshold (e.g., the temperature is less than a threshold value (e.g., 90 degrees Fahrenheit) and/or the temperature is not increasing over the previous threshold amount of time), and denies the request if thermal conditions do not satisfy a threshold (e.g., the temperature is equal to or greater than a threshold value (e.g., 90 degrees Fahrenheit) and/or the temperature is increasing over the previous threshold amount of time).

In one or more embodiments, the computing device 102 includes an energy estimation module that estimates energy usage during operation of the computing device 102. This energy estimation module can be part of the resource control system 138 or can be another module in the computing device 102 separate from the computing device 102. The energy estimation module keeps track of how much energy is consumed when particular processes are executed on the computing device 102. These processes are associated with different activity agents, and the energy estimation module can thus readily identify how much energy is consumed by each activity agent 140. In one or more embodiments, each activity agent 140 is associated with a particular task classification, and thus the energy estimation module can readily identify how much energy is consumed for each task performed on the computing device 102.

In one or more embodiments, the request determination module 142 uses additional information to determine whether to grant the request. As discussed above, the request for permission can include an indication of the urgency of the one or more tasks. Different tasks may be run with varying degrees of urgency. For example, a background task to reclaim disk space could normally run at a low priority, but in response to certain events or current system state (e.g., the computing device 102 is running low (e.g., less than a threshold amount remaining, such as 5%) on disk space, the priority of background task can be bumped to a higher priority. The request determination module 142 can use the urgency of the one or more tasks in various manners, such as granting requests for higher urgency (e.g., high priority) tasks prior to granting requests for lower urgency (e.g., low priority) tasks.

If the request determination module 142 determines not to grant the request from the activity agent 140, then the request determination module 142 notifies the activity agent 140 that the request is denied. In response, the activity agent does not perform the one or more tasks for which it was seeking permission at the current time. However, the activity agent 140 may send another request or resubmit the request at a later time.

If the request determination module 142 determines to grant the request, then the request determination module 142 notifies the activity agent 140 of the grant and the activity agent 140 can proceed to perform its desired one or more tasks. However, the resource control system 138 includes a revocation module 144 that continues to monitor the system state of the computing device 102, and may revoke the grant depending on changes in system state. Various different factors can be used to determine whether to revoke a grant, such as any of the factors used in deciding whether to grant the request.

The system state of the computing device 102 changes over time, and the revocation module 144 monitors this system state. In one or more embodiments, the revocation module 144 keeps track of the requests to perform tasks received from the activity agent(s) 140. The revocation module 144 monitors the system state, and as the system state changes (e.g., energy in the energy storage device(s) 136 is consumed, tasks are performed by activity agents 140), the revocation module 144 re-determines whether or not the requests would be granted if received given the current system state. This re-determination can be made at regular or irregular intervals (e.g., after some threshold amount of time has passed, such as 60 seconds) and/or in response to particular events occurring (e.g., the amount of energy in the energy storage device(s) 136 dropping by a threshold amount, such as 10%).

This re-determination can include an updated amount of energy that is expected to be used by the activity agent 140 to perform its requested one or more tasks. The updated amount of energy reflects energy already consumed by the activity agent 140 in performing is requested one or more tasks. For example, if the amount of energy that is expected to be used by the activity agent 140 in performing a task is 20 milliwatts, and the activity agent 140 has consumed 12 milliwatts so far, then in making the re-determination the revocation module 144 uses 8 milliwatts as the amount of energy that is expected to be used by the activity agent 140 to perform its requested one or more tasks.

If the revocation module 144 re-determines that a request would still be granted, then performance of the requested one or more tasks is allowed to continue. However, if the revocation module 144 re-determines that a request would not be granted, then the revocation module 144 revokes the grant. The revocation module 144 revokes the grant by communicating a revocation command to the activity agent 140 whose grant is being revoked. The revocation module 144 can communicate the revocation command to the activity agent 140 in a variety of different manners, such as using a callback technique specified by the activity agent 140 along with its request.

Additionally or alternatively, in one or more embodiments if the activity agent 140 has already used the amount of energy that was expected to be used by the activity agent 140 to perform its requested one or more tasks (or within a threshold amount of that amount of energy, such as 10%), then the revocation module determines to revoke the grant.

In response to a revocation command, the activity agent 140 takes appropriate actions to cease performing the one or more tasks. These actions can include saving state or data, ceasing sending or requesting data, setting configuration values to allow the one or more tasks to be resumed at a later time, set a timer to resubmit the request at a later time, and so forth. Additionally or alternatively, the revocation module 144 can take one or more actions to help ensure the activity agent 140 ceases performing the one or more tasks. For example, the activity agent 140 can notify a scheduler of an operating system of the computing device 102 to cease scheduling the activity agent 140 for execution for some amount of time (e.g., a threshold amount of time (such as 10 minutes) and/or until a particular event occurs (e.g., the amount of energy in the energy storage device(s) 136 rises above a threshold amount (such as 50%)), preventing I/O access by the activity agent 140, and so forth.

In one or more embodiments, when the request determination module 142 grants a request to perform one or more tasks, the request determination module 142 treats those one or more tasks as the critical or high priority tasks that the activity agent 140 desires to perform. If the activity agent 140 completes those one or more tasks without being revoked, then the activity agent 140 can submit a renewal request for permission to perform one or more additional tasks. The request determination module 142 treats the renewal request as opportunistic or low priority tasks that the activity agent 140 desires to perform. The request determination module 142 can determine whether to grant the renewal request using any of a variety of different factors, analogous to determining whether to grant the original request from the activity agent 140 for permission to perform one or more tasks. However, the request determination module 142 can further treat the renewal request as a lower priority than other requests from other activity agents 140, because the request determination module 142 treats the renewal request as a request for permission to perform lower priority tasks than those in the original request. This allows, for example, the resource control system 138 to allow usage of energy in the computing device 102 by the activity agent(s) 140 so that the high priority tasks of each activity agent 140 are given preference to use energy in the computing device over lower priority tasks.

Additionally or alternatively, rather than relying on requests and renewal requests, the activity agent(s) 140 can specify the priority of the one or more tasks for which they are requesting permission to perform. For example, the activity agent 140 can indicate whether one or more tasks are high priority or low priority. The activity agent 140 can indicate the priority of one or more tasks in various manners, such as including the priority of the one or more tasks as a parameter of the request for permission to perform the one or more tasks, invoking an appropriate API method of the request determination module 142 (e.g., the request determination module 142 may expose a low priority API for low priority tasks and a high priority API for high priority tasks).

It should be noted that, as discussed above, when determining whether to grant or deny a request, the resource control system 138 can use a duration to perform the one or more tasks rather than (or in addition to) using how much energy is consumed for each task. The duration of the task can be used in any of a variety of different manners analogous to the use of how much energy is consumed when making the determination, except that the amount of time the activity agent is expected to take to carry out the task is used rather than the amount of energy expected to be used by the activity agent to carry out the task.

In one or more embodiments, the resource control system 138 also supports a pending response to the activity agent 140 for a request for permission to perform one or more tasks. In response to the request form the activity agent 140, the resource control system 138 determines that it is not currently granting the request but will at some later time when the system conditions are conducive to allowing such performance of the one or more tasks. The resource control system 138 can make this determination based on various different information analogous to the discussion above. For example, the resource control system 138 may determine that the computing device 102 is expected to be coupled to an external power source in ten minutes, and thus that the system conditions will be conducive to allow performance of the one or more tasks in ten minutes. The pending response notifies the activity agent 140 that it has not currently been granted permission to perform the one or more tasks, but to expect to receive an indication (e.g., a token) at a later time when the resource control system 138 deems the system conditions to be conducive to perform the one or more tasks. The resource control system 138 keeps track of the pending responses sent, and subsequently sends a grant response to the activity agent 140 when the system conditions to be conducive to perform the one or more tasks so that the activity agent 140 can perform the one or more tasks. This allows tasks to run opportunistically as opposed to when the activity agent wants them to run, allowing resource control system 138 to further control energy utilization in the computing device 102.

In one or more embodiments, the resource control system 138 may delay responding to the request from the activity agent 140 without sending a pending response. This also allows tasks to run opportunistically as opposed to when the activity agent wants them to run, allowing resource control system 138 to further control energy utilization in the computing device 102, but does so without implementing a pending response to the activity agent 140.

In one or more embodiments, the resource control system 138 also includes a quota monitoring module 146. An activity agent 140 can query the quota monitoring module 146 for an indication of the available energy quota (also referred to herein as an activity quota) the activity agent 140 has remaining. The energy quota refers to the amount of energy expected to be used by the activity agent 140 to carry out one or more tasks (as indicated or determined with the request for permission to perform the one or more tasks), and the available energy quota refers to how much of that energy has not yet been expended due to the activity agent performing the one or more tasks. The activity agent 140 can query the quota monitoring module 146 in various manners, such as by invoking an API method exposed by the quota monitoring module 146.

In response to the query for an indication of the available energy quota the activity agent has remaining, the quota monitoring module 146 obtains an indication of or otherwise determines how much energy has been consumed by the activity agent 140 since the request for permission to perform the one or more actions was received. This amount of energy consumed by the activity agent 140 is subtracted from the amount of energy expected to be used by the activity agent 140 to carry out one or more tasks to obtain the available energy quota. The quota monitoring module 146 returns an indication of the available energy quota to the activity agent 140.

The activity agent 140 can use the available energy quota in various different manners. In one or more embodiments, the one or more tasks are made up of multiple different steps or parts. The available energy quota can be used to determine which steps or parts are to be performed prior to which other steps or parts. For example, in situations in which more energy is being expended to perform the one or more tasks than was anticipated by the activity agent 140, the available energy quota notifies the activity agent 140 that all steps or parts of the one or more tasks may not be completed before the request is revoke, so the activity agent 140 can prioritize which steps or parts are performed before other steps or parts (e.g., performing more important or higher priority parts before less important or lower priority parts).

It should be noted that the techniques discussed herein dynamically adapt to the system state in the computing device 102 as well as the amount of energy taken to perform various tasks by activity agents. The amount of energy consumed by performance of one or more actions by an activity agent can change over time. For example, as the amount of data stored on a disk drives increases, the amount of energy consumed in performing maintenance on the disk drive can also increase. The techniques discussed herein allow the resource control system 138 to adapt to such changes, rather than having a developer or designer of an activity agent 140 specify how much energy is required by the activity agent.

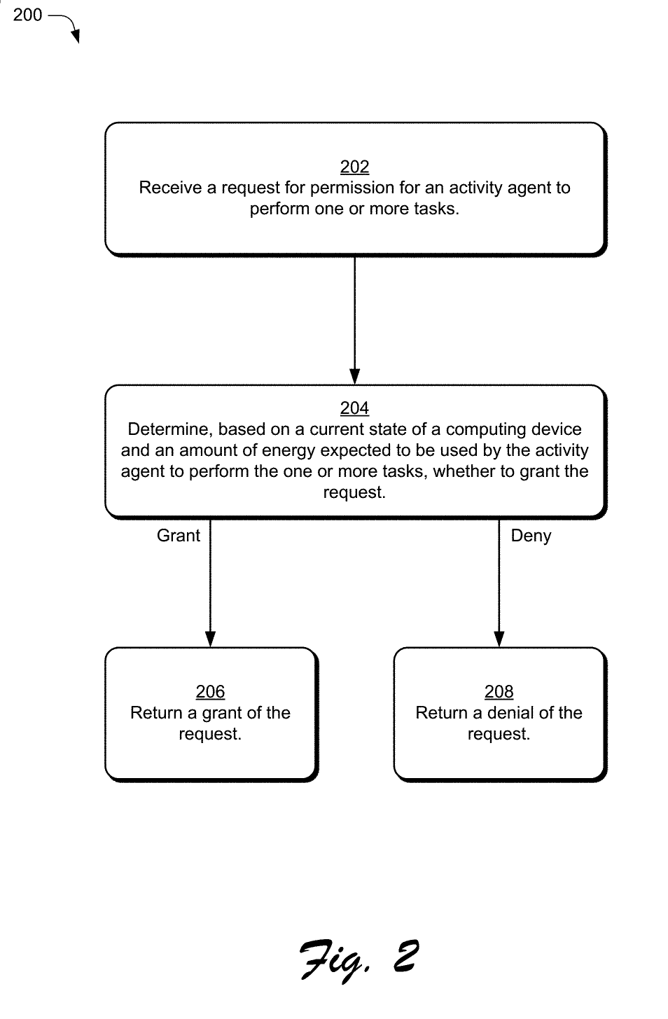

FIG. 2 is a flowchart illustrating an example process 200 for implementing controlled energy utilization in a computing device in accordance with one or more embodiments. Process 200 is carried out by a resource control system of a computing device, such as resource control system 138 of FIG. 1, and can be implemented in software, firmware, hardware, or combinations thereof. Process 200 is shown as a set of acts and is not limited to the order shown for performing the operations of the various acts. Process 200 is an example process for implementing controlled energy utilization in a computing device; additional discussions of implementing controlled energy utilization in a computing device are included herein with reference to different figures.

In process 200, a request for permission for an activity agent to perform one or more tasks is received (act 202). The request is received from the activity agent. The request can optionally have one or more parameters, such as a classification of the one or more tasks, a priority of the one or more tasks, and so forth.

Based on a current state of the computing device and an amount of energy expected to be used by the activity agent to perform the one or more tasks, a determination is made whether to grant the request (act 204). This determination can be made based on various different factors as discussed above, such as an amount of energy remaining in energy storage device(s) of the computing device, predicted future access for the computing device to an external power source, thermal conditions of the computing device, and so forth. Additionally or alternatively, the determination can be made based on the amount of time the activity agent is expected to take to carry out the task as discussed above.

In response to a determination to grant the request, a grant of the request is returned to the activity agent (act 206). The activity agent can then perform the one or more tasks.

In response to a determination not to grant the request, a denial of the request is returned to the activity agent (act 208). The activity agent does not perform the one or more tasks at the current time, but can optionally submit another request for permission to perform the one or more tasks at a later time.

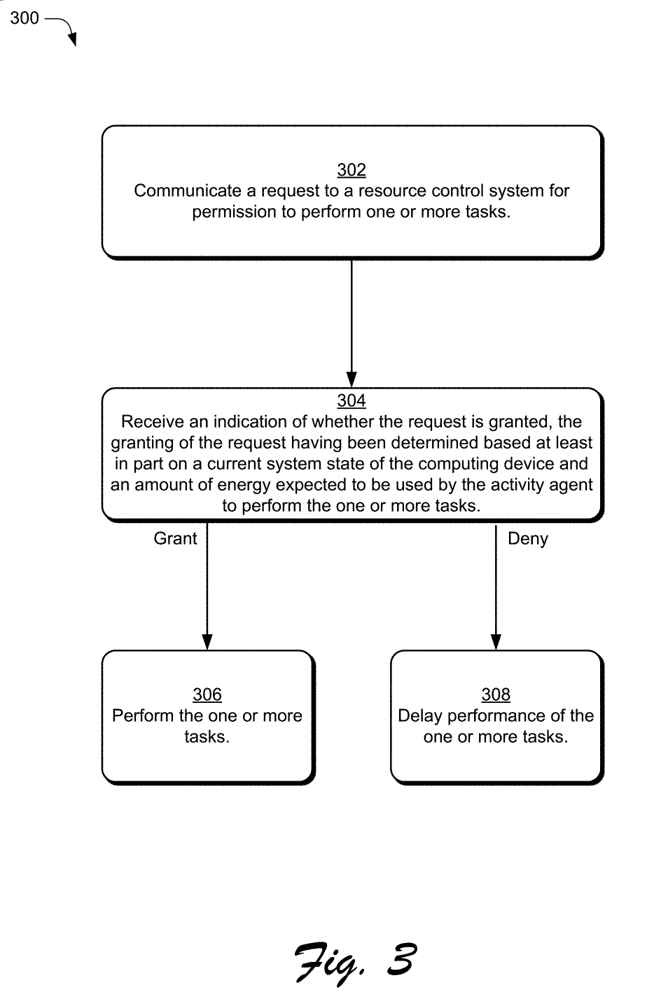

FIG. 3 is a flowchart illustrating another example process 300 for implementing controlled energy utilization revocation in a computing device in accordance with one or more embodiments. Process 300 is carried out by an activity agent of a computing device, such as an activity agent 140 of FIG. 1, and can be implemented in software, firmware, hardware, or combinations thereof. Process 300 is shown as a set of acts and is not limited to the order shown for performing the operations of the various acts. Process 300 is an example process for implementing controlled energy utilization revocation in a computing device; additional discussions of implementing controlled energy utilization in a computing device are included herein with reference to different figures.

In process 300, a request for permission to perform one or more tasks is communicated to a resource control system (act 302). The request can optionally have one or more parameters, such as a classification of the one or more tasks, a priority of the one or more tasks, and so forth.

An indication of whether the request is granted is received from the resource control system (act 304). The determination of whether to grant the request is based on a current state of the computing device and an amount of energy expected to be used by the activity agent to perform the one or more tasks. This determination can be made based on various different factors as discussed above, such as an amount of energy remaining in energy storage device(s) of the computing device, predicted future access for the computing device to an external power source, thermal conditions of the computing device, user intent, and so forth.

In response to an indication that the request is granted the one or more tasks are performed (act 306).

In response to an indication that the request is not granted, performance of the one or more tasks is delayed (act 308). The request can optionally be submitted again at a later time, such as after a threshold amount of time (e.g., 30 minutes) elapses.

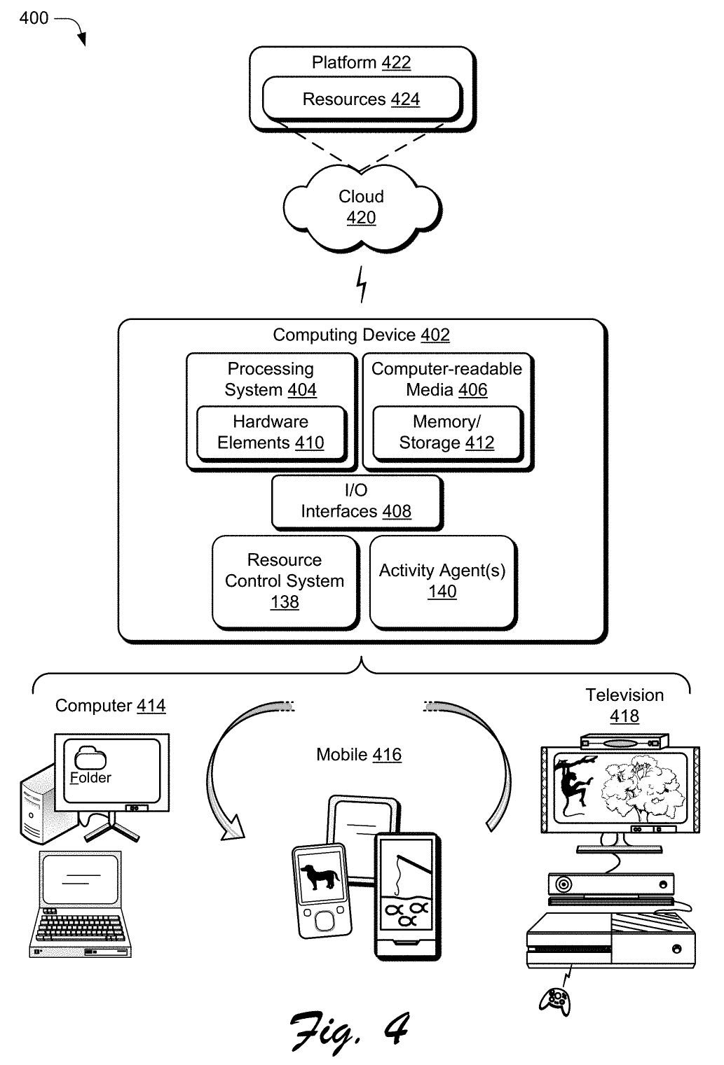

FIG. 4 illustrates an example system 400 that includes an example computing device 402 that is representative of one or more computing systems and/or devices that may implement the various techniques described herein. The computing device 402 may be, for example, a mobile device, a wearable device, an on-chip system, and/or any other suitable computing device or computing system.

The example computing device 402 as illustrated includes a processing system 404, one or more computer-readable media 406, and one or more I/O interfaces 408 that are communicatively coupled, one to another. Although not shown, the computing device 402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 404 is representative of functionality to perform one or more operations using hardware. Accordingly, the processing system 404 is illustrated as including hardware elements 410 that may be configured as processors, functional blocks, and so forth. This may include implementation in hardware as an application specific integrated circuit or other logic device formed using one or more semiconductors. The hardware elements 410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 406 is illustrated as including memory/storage 412. The memory/storage 412 represents memory/storage capacity associated with one or more computer-readable media. The memory/storage 412 may include volatile media (such as random access memory (RAM)) and/or nonvolatile media (such as read only memory (ROM), Flash memory, optical disks, magnetic disks, and so forth). The memory/storage 412 may include fixed media (e.g., RAM, ROM, a fixed hard drive, and so on) as well as removable media (e.g., Flash memory, a removable hard drive, an optical disc, and so forth). The computer-readable media 406 may be configured in a variety of other ways as further described below.

Input/output interface(s) 408 are representative of functionality to allow a user to enter commands and information to computing device 402, and also allow information to be presented to the user and/or other components or devices using various input/output devices. Examples of input devices include a keyboard, a cursor control device (e.g., a mouse), a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 402. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to signal-bearing media that is configured to transmit instructions to the hardware of the computing device 402, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 410 and computer-readable media 406 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including the resource control system 138 and the activity agent 140 may be implemented as one or more instructions and/or logic embodied on some form of computer-readable storage media and/or by one or more hardware elements 410. The computing device 402 may be configured to implement particular instructions and/or functions corresponding to the software and/or hardware modules. Accordingly, implementation of modules as a module that is executable by the computing device 402 as software may be achieved at least partially in hardware, e.g., through use of computer-readable storage media and/or hardware elements 410 of the processing system. The instructions and/or functions may be executable/operable by one or more articles of manufacture (for example, one or more computing devices 402 and/or processing systems 404) to implement techniques, modules, and examples described herein.

As further illustrated in FIG. 4, the example system 400 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 400, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 402 may assume a variety of different configurations, such as for computer 414, mobile 416, and television 418 uses. Each of these configurations includes devices that may have generally different constructs and capabilities, and thus the computing device 402 may be configured according to one or more of the different device classes. For instance, the computing device 402 may be implemented as the computer 414 class of a device that includes a personal computer, desktop computer, a multi-screen computer, laptop computer, netbook, and so on.

The computing device 402 may also be implemented as the mobile 416 class of device that includes mobile devices, such as a mobile phone, portable music player, portable gaming device, a tablet computer, a multi-screen computer, and so on. The computing device 402 may also be implemented as the television 418 class of device that includes devices having or connected to generally larger screens in casual viewing environments. These devices include televisions, set-top boxes, gaming consoles, and so on.

The techniques described herein may be supported by these various configurations of the computing device 402 and are not limited to the specific examples of the techniques described herein. This is illustrated through inclusion of the schedule-based energy storage device selection system 126 and the energy storage device system 128 on the computing device 402. The functionality represented by schedule-based energy storage device selection system 126 and other modules/applications may also be implemented all or in part through use of a distributed system, such as over a “cloud” 420 via a platform 422 as described below.

The cloud 420 includes and/or is representative of a platform 422 for resources 424. The platform 422 abstracts underlying functionality of hardware (e.g., servers) and software resources of the cloud 420. The resources 424 may include applications and/or data that can be utilized while computer processing is executed on servers that are remote from the computing device 402. Resources 424 can also include services provided over the Internet and/or through a subscriber network, such as a cellular or Wi-Fi network.

The platform 422 may abstract resources and functions to connect the computing device 402 with other computing devices. The platform 422 may also serve to abstract scaling of resources to provide a corresponding level of scale to encountered demand for the resources 424 that are implemented via the platform 422. Accordingly, in an interconnected device embodiment, implementation of functionality described herein may be distributed throughout the system 400. For example, the functionality may be implemented in part on the computing device 402 as well as via the platform 422 that abstracts the functionality of the cloud 420.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method implemented on a computing device, the method comprising: receiving a request, from an activity agent on the computing device, for permission to perform one or more tasks, the request having an associated amount of energy that is expected to be used by the activity agent to perform the one or more tasks, an associated duration to perform the one or more tasks, an associated urgency of the one or more tasks, and/or an associated classification of the one or more tasks; determining, based at least in part on a current system state of the computing device and the amount of energy expected to be used by the activity agent to perform the one or more tasks, whether to grant the request; returning, in response to determining not to grant the request, a denial of the request to the activity agent; and returning, in response to determining to grant the request, a grant of the request to the activity agent.

Alternatively or in addition to any of the above described methods, any one or combination of: the method further comprising exposing an application programming interface (API) method, and the receiving the request comprising receiving the request via the API method; the request including an indication of the amount of energy, and the indication of the amount of energy comprising a percentage of an amount of energy of an energy storage device of the computing device; the method further comprising determining the amount of energy based on previous performances of the one or more tasks; the one or more tasks having an associated classification, the determining whether to grant the request comprising determining whether to grant the request based on a system budget for energy usage by tasks having the same classification as the one or more tasks; the determining whether to grant the request comprising determining whether to grant the request based on current thermal conditions in the computing device; the determining whether to grant the request comprising determining whether to grant the request based on current and/or future coupling of internal energy storage devices, external energy storage devices, and/or power sources; the method further comprising monitoring the system state, and revoking the grant in response to a change in the system state; the method further comprising receiving a renewal request having an associated amount of energy that is expected to be used by the activity agent to perform one or more tasks additional tasks, the one or more additional tasks being treated as lower priority tasks than the one or more tasks for which permission to perform was previously received; the method further comprising receiving a query from the activity agent for an available energy and/or time quota the activity agent has remaining, determining how much of the amount of energy that is expected to be used by the activity agent to perform the one or more tasks has been consumed by the activity agent, and returning to the activity agent as the available energy quota an indication of the difference between the amount of energy that is expected to be used by the activity agent to perform the one or more tasks and the amount of energy that has been consumed by the activity agent; the method further comprising delaying returning the denial or the grant in order to coalesce the one or more tasks.

A method implemented in a computing device, the method comprising: communicating a request, to a resource control system for permission to perform one or more tasks, the request having an associated amount of energy that is expected to be used by an activity agent to perform the one or more tasks, an associated duration to perform the one or more tasks, an associated urgency of the one or more tasks, and/or an associated classification of the one or more tasks; receiving an indication of whether the request is granted, the granting of the request having been determined based at least in part on a current system state of the computing device and the amount of energy expected to be used by the activity agent to perform the one or more tasks; performing, in response to the request being granted, the one or more tasks; and delaying, in response to the request being denied, performance of the one or more tasks.

Alternatively or in addition to any of the above described methods, any one or combination of: the one or more tasks having an associated classification, and the communicating comprising communicating, as a parameter of the request, an indication of the associated classification; the method further comprising receiving, after receiving an indication that the request has been granted, an indication that the request has been revoked, and ceasing performing the one or more tasks in response to the indication that the request has been revoke; the method further comprising communicating, after completing the one or more tasks, a renewal request to the resource control system, the renewal request having an associated amount of energy that is expected to be used by the activity agent to perform one or more tasks additional tasks, the one or more additional tasks being treated as lower priority tasks than the completed one or more tasks; the method further comprising communicating a query to the resource control system for an available energy and/or time quota remaining, the available energy quota indicating an amount of energy that was expected to be used to perform the one or more tasks but has not yet been expended, and in response to determining that the available energy quota is less than expected, prioritizing performance of parts of the one or more tasks so that higher priority parts of the one or more tasks are performed prior to lower priority parts of the one or more tasks.

A computing device comprising: one or more processors; an activity agent; and a computer-readable storage medium having stored thereon multiple instructions that, responsive to execution by the one or more processors, cause the one or more processors to: receive a request, from the activity agent, for permission to perform one or more tasks, the request having an associated amount of energy that is expected to be used by the activity agent to perform the one or more tasks, an associated duration to perform the one or more tasks, an associated urgency of the one or more tasks, and/or an associated classification of the one or more tasks; determine, based at least in part on a system state of the computing device and the amount of energy expected to be used by the activity agent to perform the one or more tasks, whether to grant or deny the request; return, in response to determining to deny the request, a denial of the request to the activity agent; and return, in response to determining to grant the request, a grant of the request to the activity agent.

Alternatively or in addition to any of the above described computing devices, any one or combination of: wherein the multiple instructions further cause the one or more processors to determine the amount of energy based on previous performances of the one or more tasks; wherein the multiple instructions further cause the one or more processors to monitor the system state, and revoke the grant in response to a change in the system state; wherein the multiple instructions further cause the one or more processors to receive a renewal request having an associated amount of energy that is expected to be used by the activity agent to perform one or more tasks additional tasks, the one or more additional tasks being treated as lower priority tasks than the one or more tasks for which permission to perform was previously received.

### CONCLUSION

Although the example implementations have been described in language specific to structural features and/or methodological acts, it is to be understood that the implementations defined in the appended claims are not necessarily limited to the specific features or acts described. Rather, the specific features and acts are disclosed as example forms of implementing the claimed features.

What is claimed is:

1. A method implemented on a computing device, the method comprising:
receiving a request, from an activity agent on the computing device, for permission to perform one or more tasks, the request having an associated amount of energy that is expected to be used by the activity agent to perform the one or more tasks, an associated duration to perform the one or more tasks, an associated urgency of the one or more tasks, and/or an associated classification of the one or more tasks;
determining, based at least in part on a current system state of the computing device and the amount of energy expected to be used by the activity agent to perform the one or more tasks, whether to grant the request;
returning, in response to determining not to grant the request, a denial of the request to the activity agent; and
returning, in response to determining to grant the request, a grant of the request to the activity agent.

2. The method as recited in claim 1, the method further comprising exposing an application programming interface (API) method, and the receiving the request comprising receiving the request via the API method.

3. The method as recited in claim 1, the request including an indication of the amount of energy, and the indication of the amount of energy comprising a percentage of an amount of energy of an energy storage device of the computing device.

4. The method as recited in claim 1, further comprising determining the amount of energy based on previous performances of the one or more tasks.

5. The method as recited in claim 1, the one or more tasks having an associated classification, the determining whether to grant the request comprising determining whether to grant the request based on a system budget for energy usage by tasks having the same classification as the one or more tasks.

6. The method as recited in claim 1, the determining whether to grant the request comprising determining whether to grant the request based on current thermal conditions in the computing device.

7. The method as recited in claim 1, the determining whether to grant the request comprising determining whether to grant the request based on current and/or future coupling of internal energy storage devices, external energy storage devices, and/or power sources.

8. The method as recited in claim 1, further comprising monitoring the system state, and revoking the grant in response to a change in the system state.

9. The method as recited in claim 1, further comprising receiving a renewal request having an associated amount of energy that is expected to be used by the activity agent to perform one or more tasks additional tasks, the one or more additional tasks being treated as lower priority tasks than the one or more tasks for which permission to perform was previously received.

10. The method as recited in claim 1, further comprising:
receiving a query from the activity agent for an available energy and/or time quota the activity agent has remaining;
determining how much of the amount of energy that is expected to be used by the activity agent to perform the one or more tasks has been consumed by the activity agent; and
returning to the activity agent as the available energy quota an indication of the difference between the amount of energy that is expected to be used by the activity agent to perform the one or more tasks and the amount of energy that has been consumed by the activity agent.

11. The method as recited in claim 1, further comprising delaying returning the denial or the grant in order to coalesce the one or more tasks.

12. A method implemented in a computing device, the method comprising:
communicating a request, to a resource control system for permission to perform one or more tasks, the request having an associated amount of energy that is expected to be used by an activity agent to perform the one or more tasks, an associated duration to perform the one or more tasks, an associated urgency of the one or more tasks, and/or an associated classification of the one or more tasks;
receiving an indication of whether the request is granted, the granting of the request having been determined based at least in part on a current system state of the computing device and the amount of energy expected to be used by the activity agent to perform the one or more tasks;
performing, in response to the request being granted, the one or more tasks; and
delaying, in response to the request being denied, performance of the one or more tasks.

13. The method as recited in claim 12, the one or more tasks having an associated classification, and the communicating comprising communicating, as a parameter of the request, an indication of the associated classification.

14. The method as recited in claim 12, further comprising:
receiving, after receiving an indication that the request has been granted, an indication that the request has been revoked; and
ceasing performing the one or more tasks in response to the indication that the request has been revoke.

15. The method as recited in claim 12, further comprising communicating, after completing the one or more tasks, a renewal request to the resource control system, the renewal request having an associated amount of energy that is expected to be used by the activity agent to perform one or more tasks additional tasks, the one or more additional tasks being treated as lower priority tasks than the completed one or more tasks.

16. The method as recited in claim 12, further comprising:
communicating a query to the resource control system for an available energy and/or time quota remaining, the available energy quota indicating an amount of energy that was expected to be used to perform the one or more tasks but has not yet been expended; and
in response to determining that the available energy quota is less than expected, prioritizing performance of parts of the one or more tasks so that higher priority parts of the one or more tasks are performed prior to lower priority parts of the one or more tasks.

17. A computing device comprising:
one or more processors;
an activity agent; and
a computer-readable storage medium having stored thereon multiple instructions that, responsive to execution by the one or more processors, cause the one or more processors to:
receive a request, from the activity agent, for permission to perform one or more tasks, the request having an associated amount of energy that is expected to be used by the activity agent to perform the one or more tasks, an associated duration to perform the one or more tasks, an associated urgency of the one or more tasks, and/or an associated classification of the one or more tasks;
determine, based at least in part on a system state of the computing device and the amount of energy expected to be used by the activity agent to perform the one or more tasks, whether to grant or deny the request;
return, in response to determining to deny the request, a denial of the request to the activity agent; and
return, in response to determining to grant the request, a grant of the request to the activity agent.

18. The computing device as recited in claim 17, wherein the multiple instructions further cause the one or more processors to determine the amount of energy based on previous performances of the one or more tasks.

19. The computing device as recited in claim 17, wherein the multiple instructions further cause the one or more processors to monitor the system state, and revoke the grant in response to a change in the system state.

20. The computing device as recited in claim 17, wherein the multiple instructions further cause the one or more processors to receive a renewal request having an associated amount of energy that is expected to be used by the activity agent to perform one or more tasks additional tasks, the one or more additional tasks being treated as lower priority tasks than the one or more tasks for which permission to perform was previously received.
